(19) United States
(12) Patent Application Publication
(10) Pub. No.: US 2024/0426553 A1
(43) Pub. Date: Dec. 26, 2024

(54) INDUSTRIAL FURNACE SYSTEM

(71) Applicant: EBNER Industrieofenbau GmbH, Leonding (AT)

(72) Inventors: Robert EBNER, Gmunden (AT); Tong LI, Leonding (AT); Rene HAMMER, Graz (AT); Stefan DEFREGGER, Lieboch (AT)

(73) Assignee: EBNER Industrieofenbau GmbH, Leonding (AT)

(21) Appl. No.: 18/700,837

(22) PCT Filed: Oct. 13, 2022
(86) PCT No.: PCT/AT2022/060357

§ 371 Date: Apr. 12, 2024

(30) Foreign Application Priority Data
Oct. 15, 2021 (AT) A 50826/2021

(51) Int. Cl. F27B 14/12; C04B 35/573; F27B 14/06; F27B 17/00

(52) U.S. Cl. CPC F27B 14/12; C04B 35/573; F27B 14/061; F27B 17/0016

(57) ABSTRACT

An industrial furnace system, particularly for producing ceramic materials and/or carbides, includes at least one furnace with a chamber having a loading opening for loading the chamber, a heating device and a closure device for the opening, a control device and a transfer device for transferring a crucible that can be placed in the chamber to and/or from the furnace. To remove the crucible from the chamber, the control device is configured to bring the closure device—by actuating the transfer device and/or depending on the position of the transfer device and/or an end effector thereof—into the release position and/or to allow for a crucible to be removed through the opening when the closure device is in the release position by actuating the transfer device and/or preferably depending on the transfer device and/or end effector position by actuating a removal device separate from the transfer device.

The invention relates to an industrial furnace system, in particular for producing ceramic materials and/or carbides, in particular silicon carbide, comprising
at least one furnace, in particular a reaction furnace, with a chamber—preferably one which can be evacuated and/or can have an inert atmosphere applied to it—in particular a reaction chamber which has a loading opening, preferably arranged on its underside, for loading the chamber with a crucible which is filled with a—preferably powdered—starting material, a heating device, preferably in the form of an induction coil and/or induction heater, for heating a starting material brought into the furnace, and a closure device for the loading opening, said closure device being operable between a closed position and a release position, and
a control device for controlling the at least one furnace.

The invention also relates to a method for operating an industrial furnace system and a method for producing ceramic materials and/or carbides.

Industrial furnace systems are required to produce materials and high-performance materials such as ceramics. The term production also covers the (post-) processing of (semi-finished) products, such as sintering. In particular, the loading of such furnaces poses a major challenge in industrial applications. On the one hand, the high temperatures have to be taken into consideration when unloading the furnaces, and on the other hand the time taken to unload and reload the furnaces ought to be kept as short as possible. There is therefore a demand for fast, reliable and temperature-resistant unloading/loading. A crucible prepared with starting material outside the furnace is thereby brought into a chamber of the furnace and heated there. After the starting material has been heated, which can trigger an (exothermic) reaction or a (reaction) sintering process, for instance, the crucible with the (reaction) product can be removed from the chamber again.

The object of the present invention was to overcome the disadvantages of the prior art and provide an industrial furnace system and a method for operating the same by means of which a fast and reliable unloading of the crucible from the chamber of the furnace can be carried out. It should thereby also be made possible to carry out the unloading as soon after the treatment of the material as possible, i.e. at still elevated temperatures. The intervention thereby required by an operator is to be kept to a minimum.

This object is solved by an industrial furnace system and method according to the claims. The industrial furnace system comprises a transfer device, preferably in the form of a robot, for transferring a crucible that can be brought into the chamber through the loading opening to the and/or from the furnace, preferably between the furnace and a loading and/or unloading station for loading and/or unloading a crucible or a transfer station,
wherein, for removing the crucible from the chamber, the control device is configured to bring the closure device (from the closed position) into the release position
by actuating the transfer device and/or depending on the position of the transfer device and/or the position of an end effector of the transfer device
and/or
to allow for a crucible to be removed, in particular to be lowered, through the loading opening of the chamber when the closure device is in the release position, by actuating the transfer device and/or preferably depending on the position of the transfer device and/or on the position of an end effector of the transfer device by actuating a removal device, in particular a lowering device, which is separate from the transfer device.

The removal process is automated by the measures according to the invention, wherein in particular the speed and reliability of the unloading of the chamber (reaction chamber and/or sintering chamber) are increased.

In one variation, the closure device can by actuated directly by the transfer device, in particular by an end effector of the transfer device (in this case the closure device could be configured as a passive closure device).

In another variation, the closure device itself is active, i.e. it comprises at least one own (separate from the transfer device or furnace-side) actuator which performs the actuation. Nevertheless, in this variation the actuation of the closure device is also performed depending on the position of the transfer device and/or the position of an end effector of the transfer device. The control device, which in this variation has a control connection with the actuator, knows the position of the transfer device or its end effector (e.g. from sensor data and/or because the control device also controls the transfer device) and controls the at least one actuator of the closure device depending on this position. The closure device is brought into a release position by the control device in particular if the transfer device and/or its end effector is in a position in which it is ready to receive the crucible or a support carrying the crucible. This is the case, for instance, if the transfer device has arrived in the region of the loading opening and/or has docked with the chamber or the support.

Similar can apply for the removal of the crucible from the chamber through the loading opening. If the closure device is in a release position, in one variation the crucible can be removed from the chamber by means of actuation of the transfer device. In another variation, this is performed by means of actuation of a removal device, in particular a lowering device, which is separate from the transfer device, preferably also depending on the position of the transfer device and/or the position of an end effector of the transfer device. For example, upon the transfer device approaching the furnace or chamber (e.g., as of a certain position), the removal device could be activated to remove the crucible from the chamber. Alternatively, the removal device could also be activated to remove the crucible independently of the transfer device.

The opening of the closure device and/or the removal of the crucible from the chamber can be performed either by the transfer device itself (the transfer device is the actuator here) or preferably depending on the position of the transfer device and/or its end effector (here the transfer device acts as a trigger for the actuation and/or removal process).

The closure device can have a mechanical locking mechanism and/or fixing mechanism and, for example, be constructed from one or more levers, in particular a toggle lever. Naturally, other mechanical locking elements (e.g., sliders, pins or the like) can also be used.

The triggering of the aforementioned processes (closure device, removal device) can then be performed, for example, if the transfer device or its end effector enters a transfer position (in which it can take over the crucible and/or a crucible support) or if the transfer device or its end effector is on the way to the chamber or is approaching the chamber (approach position). In both cases, the position of the transfer device or its end effector can be decisive. The term position is further understood as also denoting a status of the transfer device or its end effector and a possible contacting position (docking in the region of the loading opening of the chamber).

The position of the transfer device and/or its end effector can be detected with one or more sensors, e.g., a proximity sensor and/or a contact sensor and/or an image capture sensor (camera). The sensor data can be evaluated by the control device and the control device thereupon generates control signals for the closure device and/or a removal device.

Depending on the configuration of the furnace and the loading opening, the removal can, for example, be performed by a lowering and/or any other movement. Preferably, the chamber is cylindrical and the crucible or crucible support is moved into or out of the chamber along the cylindrical axis.

In the case of a removal device which is separate from the transfer device, it can, for example, be a lowering device (e.g., a lowerable platform which lowers the crucible and/or a crucible support to a lower level (below the chamber)). The removal movement can be performed by means of a drive of the removal device, e.g., by means of a motor and/or a cylinder.

The industrial furnace system according to the invention is suitable for all types of treatment of (starting) materials provided in a crucible. The furnace can thus be a reaction furnace or sintering furnace, for example. Reaction sintering, where a sintering process is superposed with a chemical reaction, would also be conceivable in an industrial furnace system according to the invention. In particular where reaction processes are performed, it is an industrial furnace in which temperatures of over 1000° C., in particular also over 2000° C., can be generated in the chamber. They are thus in particular high-temperature furnaces.

In turn, the starting materials can be of any nature, comprising powder, granular and/or solid materials. Preferred example applications are, for example, the production of silicon carbide from silicon oxide and carbon, the production of boron carbide from boron oxide and carbon, and fundamentally the production of various other carbides, nitrides, borides etc. Examples of reaction sintering would be the production of spinel from magnesium oxide and aluminum oxide, the production of aluminum titanate from aluminum oxide and titanium oxide, the production of fluorapatite from fluorite and tricalcium phosphate, and many more. Finally, the industrial furnace system according to the invention is also suitable for sintering or heat-treating various semi-finished products. The person skilled in the art is familiar with the fundamental chemical reactions. Reference is thus made simply by way of example to EP0000661A1, which describes the reaction for producing silicon carbide.

The term crucible is to be understood broadly and comprises containers which are suitable for receiving starting materials. During treatment in the furnace, the starting material(s) or the arising end or semi-finished product(s) is/are in the crucible. The shape and/or the material of the crucible are not subject to any limitations and can vary depending on the application. The crucible can therefore be cylindrical or pot-shaped or bowl-shaped or box-shaped, etc. The crucible can be open or closable. Similarly, it can have openings (e.g., slits, holes etc.) to enable evacuation and/or application of process gas (e.g., inert atmosphere) inside the crucible. The crucible material is selected such that it can withstand the temperatures that are reached for a special application in the (reaction) chamber.

In case of induction heating, the crucible is preferably fashioned from conductive material such as graphite, for example. The electrical energy emitted by an induction coil is converted by the crucible material into thermal energy which is transferred to the material in the crucible.

Loading, unloading and transfer stations denote stations in the industrial furnace system in which the crucible is filled with or emptied of starting material (e.g., preferably by means of suction for powder material) or transferred to an intermediate storage or a further transport device (e.g., shuttles, conveyor belt or similar).

Naturally, the furnace can also have a cooling device for cooling certain components, in particular an outer cladding of the chamber, with a coolant, in particular water.

A preferred embodiment is characterized in that the closure device has at least one, preferably pneumatic or hydraulic, actuator which can be actuated by the control device. In that embodiment, the closure device itself is active and is triggered by the control device to move from the closed to the release position and vice versa. In this case, the transfer device serves as a trigger in such a way that upon reaching a certain position (relative to the chamber or loading opening) the activation of the closure device from the closed to the release position is triggered.

A preferred embodiment is characterized in that the closure device is self-locked in the closed and/or in the release position. The individual positions are characterized by a high reliability, i.e. unintentional jumping from one position to the next is reliably prevented. The self-locking can thereby be implemented in such a way that two stable conditions (closed position on the one hand, release position on the other hand) can be switched between by overcoming a (actuation) resistance.

A preferred embodiment is characterized in that the closure device has at least one toggle lever mechanism which can be actuated by the at least one actuator.

A preferred embodiment is characterized in that the control device is configured to move the closure device into the release position by actuating the at least one actuator to remove a crucible from the chamber if an end effector of the transfer device is arranged in front of and/or beneath the loading opening and/or if an end effector of the transfer device contacts the furnace in the region of the loading opening and/or if an end effector of the transfer device contacts a support, which is supporting a crucible located in the chamber, from the outside. The transfer device serves as a trigger for enacting the opening/release of the chamber or the crucible therein. Thus, the closure device only assumes the release position if the transfer device is in a position in which it is ready to receive and/or further handle the crucible or a crucible support.

A preferred embodiment is characterized in that the furnace has at least one sensor, preferably a contact sensor and/or proximity sensor for detecting the position of the transfer device and/or the position of an end effector of the transfer device, wherein the sensor is preferably arranged in the region of the loading opening. This measure further increases reliability because it is ensured that the position is also detected. The position detection by a sensor can occur in addition to a transmission and/or registration of movement data of the transfer device (to or by means of the control device). Process reliability is thereby significantly increased.

A preferred embodiment is characterized in that the control device is configured to receive data about the position of the transfer device and/or the position of an end effector of the transfer device from a sensor and/or from the transfer device itself, and/or that the control device is configured to receive data from a temperature sensor of the furnace and to control the transfer device and/or the closure device depending on the data of the temperature sensor. These embodiments are preferred because the control device receives reliable position data on the basis of which it controls the closure device and/or a removal device (which is separate from the transfer device).

A preferred embodiment is characterized in that the furnace has a—preferably pedestal-like—support to support a crucible in the chamber, wherein in its operating position the support closes (preferably in an airtight manner) the loading opening and is fixed by the closure device and wherein the support, when the closure device is in its release position, can be removed, in particular lowered, from its operating position in the chamber, preferably by the transfer device. The support serves, on the one hand, to support the crucible so that during the removal process the (possibly still too hot) crucible does not have to be contacted itself, and on the other hand to close the loading opening. The support thus simultaneously forms the closure of the chamber. Due to the support having these two functions, the crucible handling steps during removal are especially simple.

A preferred embodiment is characterized in that an end effector of the transfer device is configured to receive the support and/or the crucible positioned on the support in the region of its underside, preferably by means of a gripper. The end effector can, for example, be a (parallel) gripper, which can either grab the support and/or the crucible itself and subsequently move it to another location.

A preferred embodiment is characterized in that in its operating position the support protrudes into the inside of the chamber. It thereby also serves to detect the position of the crucible within the chamber, such that the crucible is located correctly with respect to the heating device (e.g., induction heating).

A preferred embodiment is characterized in that the support is closed off on its underside by a base plate. The base plate serves as a closure of the loading opening and is pressed against the edge of the loading opening by the closure device.

A preferred embodiment is characterized in that the support has feet protruding downwards on its underside. These feet have the purpose of allowing for the end effector (similar to the fork of a forklift truck) to be removed from beneath the support without any problems when the support is put down by the transfer device (on the ground or on an intermediate platform).

A preferred embodiment is characterized in that at least one temperature sensor, preferably in the form of a thermocouple, is arranged in or on the support for measuring a temperature in the chamber. The temperature sensor can be connected with the control device, such that its temperature data can also be used for controlling the closure device and/or the transfer device.

These further functions are transferred by the further embodiments of the support: A preferred embodiment is characterized in that the support has at least one heat shield which is arranged in a cavity of the support. A preferred embodiment is characterized in that at least one cavity is configured in the support, preferably in the form of a duct or a water pocket, for receiving and/or conducting a coolant. A preferred embodiment is characterized in that a passage is configured in the support for a gas line and/or vacuum line and/or electrical line and/or a thermocouple.

A preferred embodiment is characterized in that the industrial furnace system has at least two furnaces combined into one unit and controllable by the control device, and that the control device is configured to unload and/or to clean and/or to reload one furnace of the unit by controlling the transfer device and/or by controlling the closure device while another furnace of the unit is in production mode. Cycle times can thereby be reduced and idle states prevented.

A preferred embodiment is characterized in that the industrial furnace system has at least two furnaces combined into one unit and controllable by the control device, wherein the unit has a common, preferably electric, supply device, preferably in the form of an induction generator for the heating devices, which are preferably configured as induction coils, said supply device being switchable between the heating devices of the furnaces, and/or wherein the unit has one common pump and/or gas loading device which is switchable between the chambers. The construction effort is thereby reduced, because certain components only have to be installed once.

A preferred embodiment is characterized in that the transfer device is guided on a guideway and/or that the transfer device comprises at least one robotic arm and/or that an end effector of the transfer device comprises a gripper, preferably a parallel gripper, and/or that an end effector of the transfer device comprises and/or carries a cleaning device, wherein the cleaning device preferably comprises a brush, which can preferably be set into rotation by a drive, and/or a suction device and/or a compressed air supply and/or a cover by means of which the loading opening can be closed. The transfer device thereby obtains a further function, namely the cleaning of the chamber following a reaction or treatment process. Automation is thereby further increased and during operation it is no longer necessary for operators to intervene in the region of the furnaces or their loading openings. The hazard potential towards people is thereby significantly reduced.

The objective is also achieved with a method for operating an industrial furnace system, in particular for producing ceramic materials and/or carbides, in particular silicon carbide, wherein the industrial furnace system has
at least one furnace, in particular a reaction furnace, with a chamber-preferably one which can be evacuated and/or can have an inert atmosphere applied to it-, in particular a reaction chamber which has a loading opening, preferably arranged on its underside, for loading the chamber with a crucible which is filled with a-preferably powdered-starting material, a heating device, preferably in the form of an induction coil and/or induction heater, for heating a starting material brought into the furnace and a closure device for the loading opening, said closure device being operable between a closed position and a release position,
a control device for controlling the at least one furnace and
a transfer device, preferably in the form of a robot, for transferring a crucible that can be brought into the chamber through the loading opening to the and/or from the furnace, preferably between the furnace and a loading and/or unloading station for loading and/or unloading a crucible or a transfer station,
   wherein for removing the crucible from the chamber
   the closure device is brought into the release position by actuation of the transfer device and/or depending on the position of the transfer device and/or the position of an end effector of the transfer device
   and/or
   a crucible is removed, in particular lowered, through the loading opening of the chamber when the closure device is in the release position by actuation of the transfer device and/or preferably depending on the position of the transfer device and/or of the position of an end effector of the transfer device by actuation of a removal device, in particular a lowering device, which is separate from the transfer device.

The advantages and further embodiment variations of the aforementioned embodiments apply equally to the following embodiments of the method according to the invention and are thus transferable to them.

A preferred embodiment of the method is characterized in that the industrial furnace system is configured according to the invention or one of the embodiments described above.

A preferred embodiment is characterized in that following the removal of the crucible from the chamber, the chamber is cleaned by means of the transfer device, wherein preferably an end effector of the transfer device comprises a cleaning device and/or carries a cleaning device during cleaning, wherein preferably the cleaning device comprises a brush and/or a suction device and/or a compressed air supply.

A preferred embodiment is characterized in that the industrial furnace system has at least two furnaces combined into one unit and controllable by the control device and that one furnace of the unit is unloaded and/or cleaned and/or reloaded by controlling the transfer device and/or by controlling the closure device while another furnace of the unit is in production mode.

A preferred embodiment is characterized in that the industrial furnace system has a plurality of furnaces, wherein preferably two furnaces are combined into one unit, and that the furnaces are unloaded and/or cleaned and/or loaded by means of the same transfer device, wherein the furnaces are put into production mode with a time offset, preferably by means of evacuating the chamber and/or by introducing an inert atmosphere into the chamber and/or by activating the heating device.

A preferred embodiment is characterized in that for removing a crucible from the chamber, the transfer device approaches the loading opening with an end effector and the closure device is brought into a release position by means of the transfer device and/or at least one actuator of the closure device.

A preferred embodiment is characterized in that the transfer device removes, in particular lowers, the crucible from the chamber.

A preferred embodiment is characterized in that the furnace has a, preferably pedestal-like, support for supporting a crucible located in the chamber, wherein when in its operating position the support closes the loading opening and is fixed by the closure device and wherein the transfer device removes the crucible from the chamber in that the transfer device removes, in particular lowers, the support together with the crucible from its operating position in the chamber.

A preferred embodiment is characterized in that an end effector of the transfer device removes the crucible from the removed, in particular lowered, support, wherein preferably the transfer device transfers the removed support to a loading and/or unloading station to load or unload the crucible or to a transfer station.

The objective is also achieved with a method for producing ceramic materials and/or carbides, in particular for producing silicon carbide from silicon oxide and carbon, by means of exothermic reaction and/or for the sintering of materials, wherein preferably powdered starting materials, in particular an oxide and carbon, are filled into a crucible, wherein the filled crucible is placed into a furnace of an industrial furnace system, wherein the industrial furnace system is configured according to the invention or according to one of the embodiments described above and/or wherein the industrial furnace system is operated according to the invention or one of the embodiments described above.

For a better understanding of the invention, it is explained in more detail with reference to the following figures.

These show in significantly simplified, schematic representation:

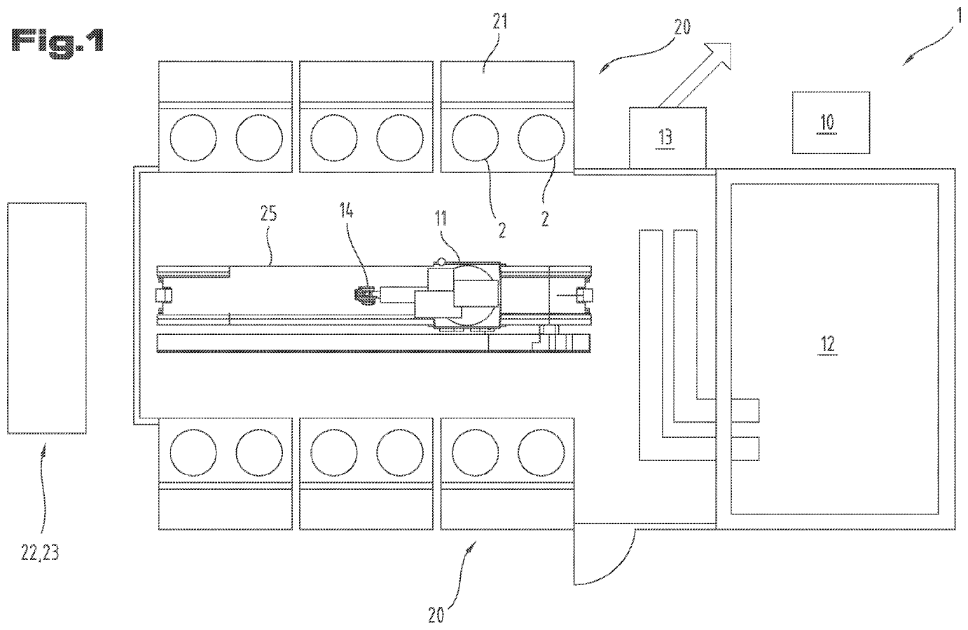

FIG. 1 an embodiment of an industrial furnace system from above;

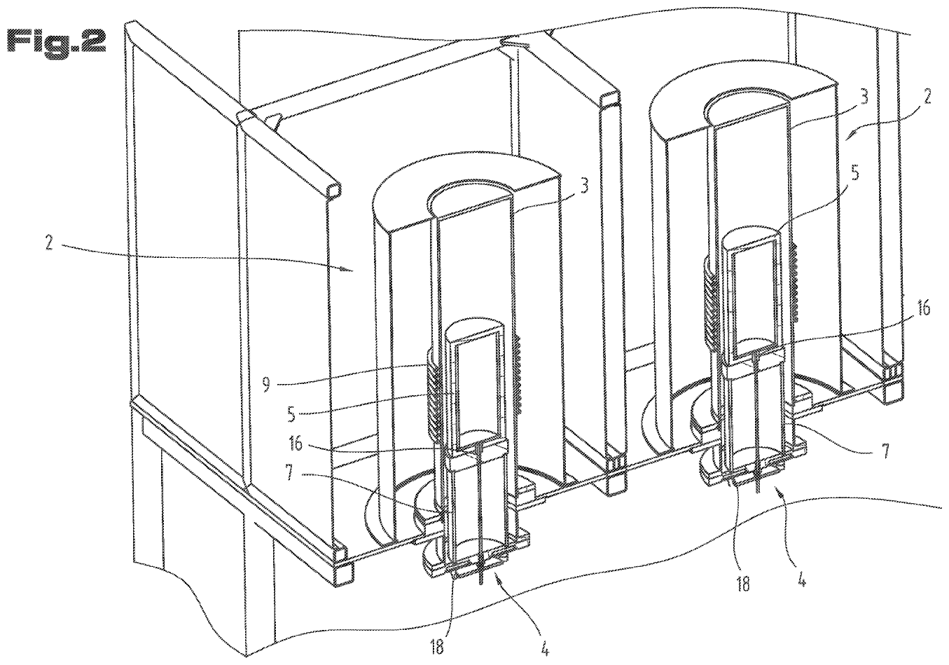

FIG. 2 two furnaces of a unit of the industrial furnace system in sectional representation;

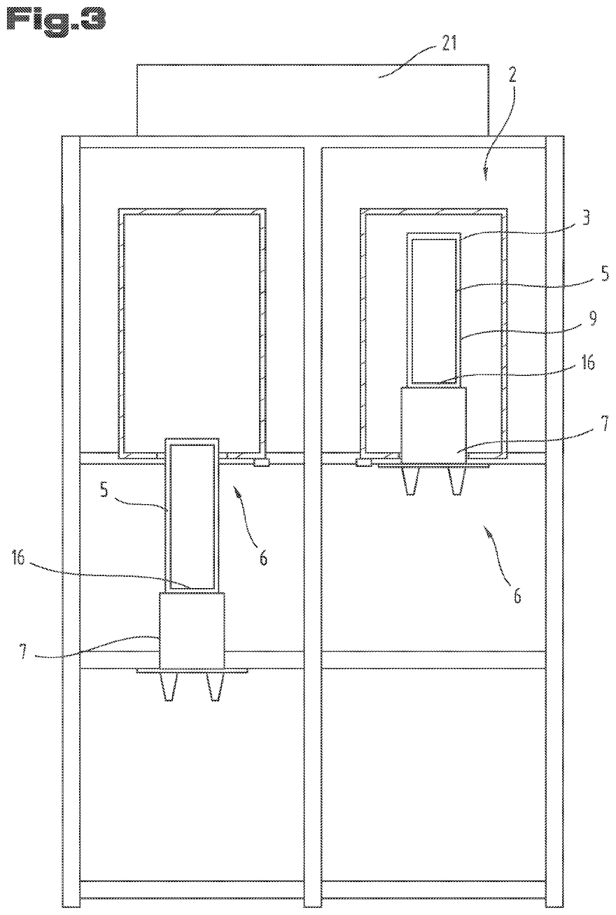

FIG. 3 two furnaces of a unit, wherein in one furnace the crucible and the crucible support are lowered;

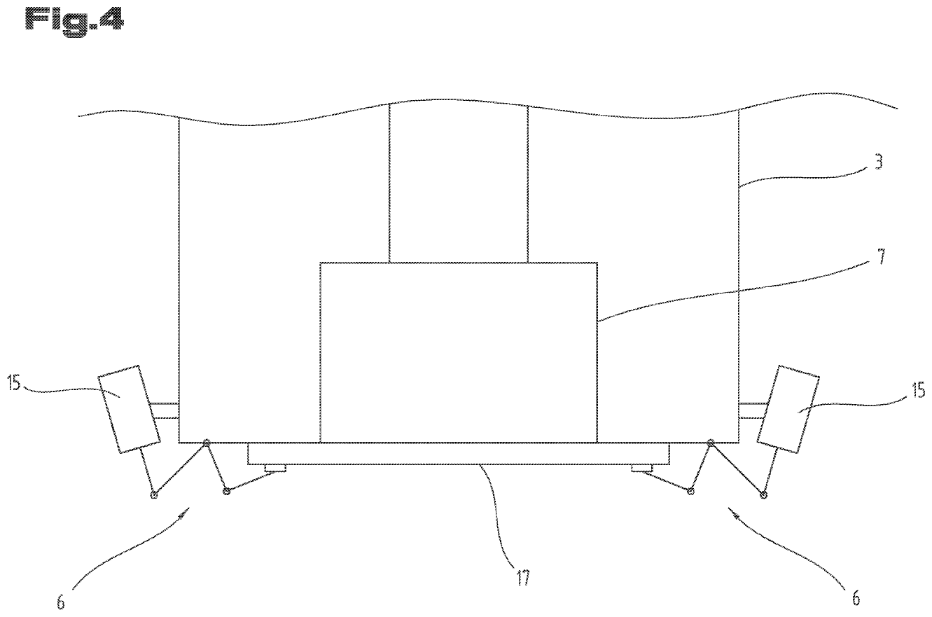

FIG. 4 the underside of the chamber in detail;

FIG. 5 two furnaces of a unit of the industrial furnace system in perspective representation;

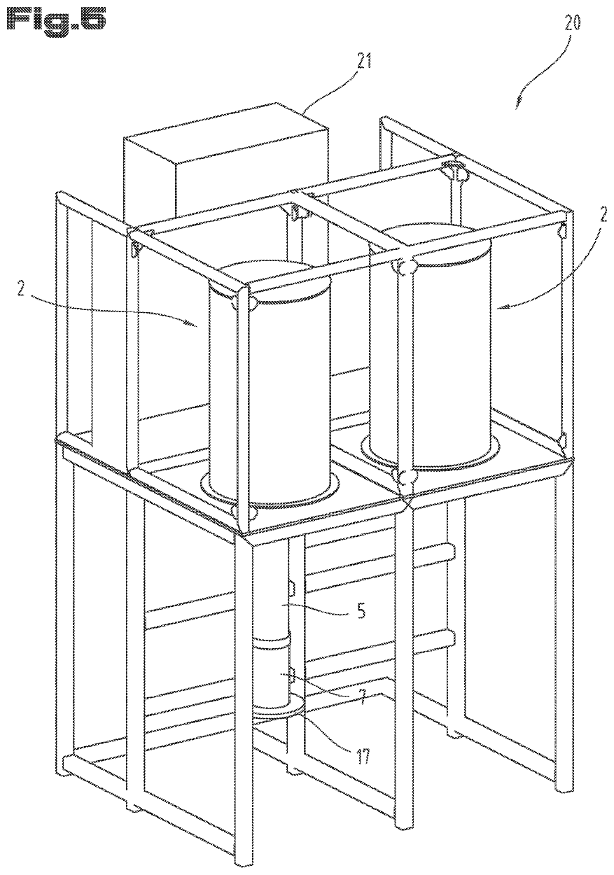

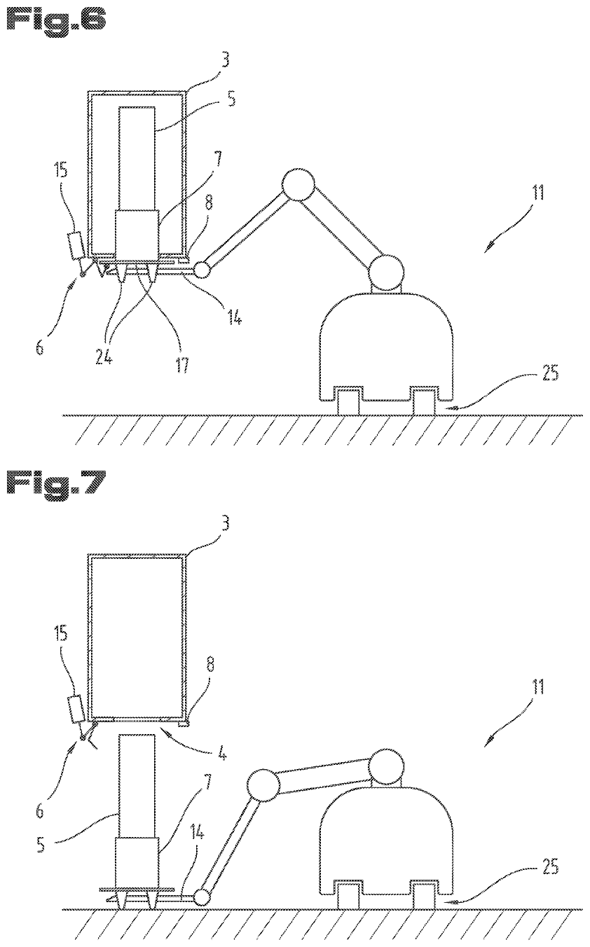

FIG. 6 the transfer device with end effector in a transfer position relative to the chamber;

FIG. 7 the transfer device with end effector in a lowered position;

FIG. 8 the transfer device with end effector in a position grabbing the crucible;

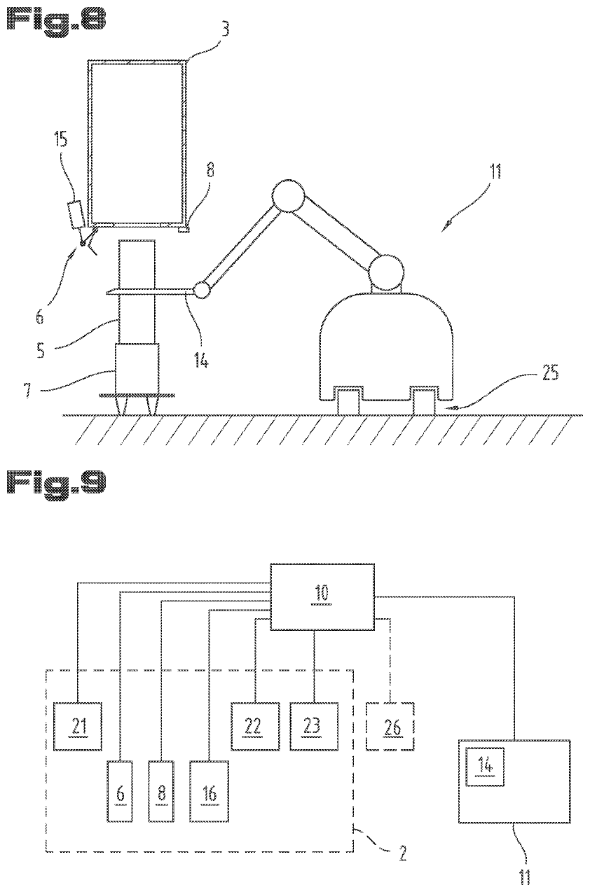

FIG. 9 the control device along with the components connected to the control device;

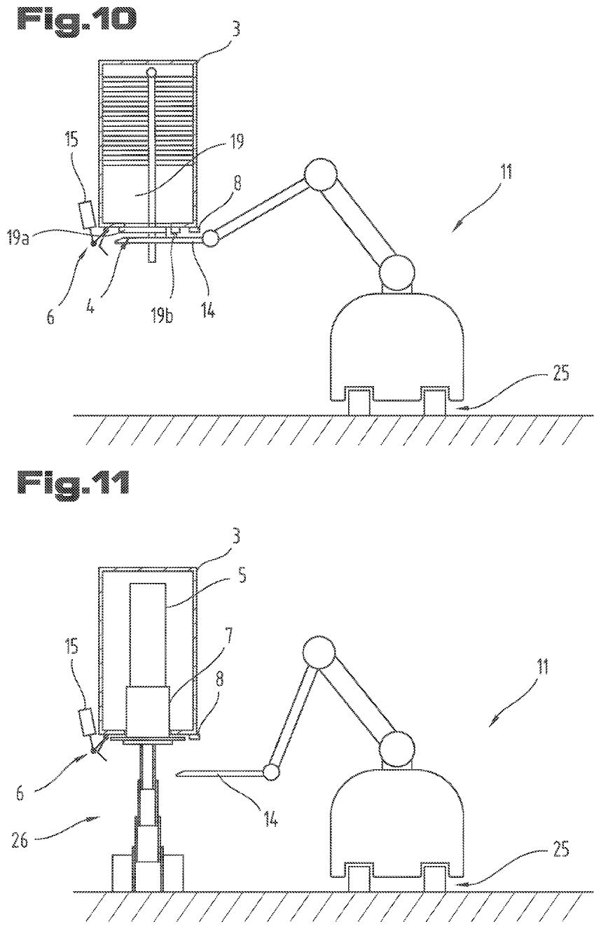

FIG. 10 the control device with a cleaning device during chamber cleaning;

FIG. 11 an embodiment with a removal device (here a lowering device) separate from the transfer device;

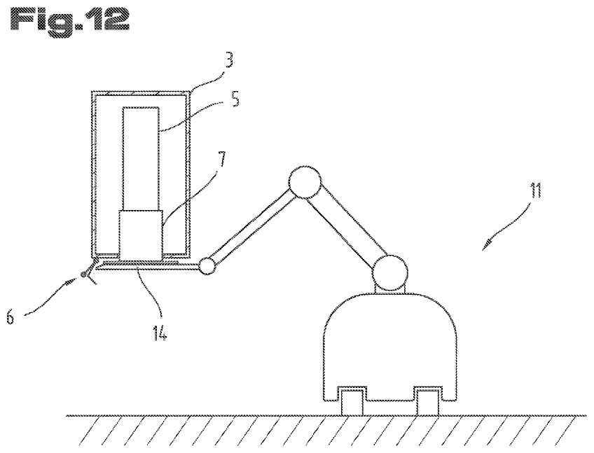

FIG. 12 an embodiment in which the transfer device actuates the closure device.

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and these indications of position can be applied in the same way to the new position should the position change.

The example embodiments show possible embodiment variations, although it is to be noted here that the invention is not limited to the specifically represented embodiment variations of the same, but rather various combinations of the individual embodiment variations with one another are possible, and that given the technical teachings provided by the present invention this variation possibility is within the ability of the skilled person in this technical field.

The scope of protection is defined by the claims. The description and the drawings should, however, be consulted when construing the claims. Individual features or combinations of features from the various example embodiments as shown and described can constitute separate inventive solutions. The problem to be solved by the individual inventive solutions can be derived from the description.

As a matter of form and by way of conclusion, it is noted that, to improve understanding of the structure, elements have partially not been shown to scale and/or enlarged and/or shrunk.

FIG. 1 shows an embodiment of an industrial furnace system 1 from above. Such a system can be used in particular for producing ceramic materials and/or carbides, in particular silicon carbide, but is fundamentally suitable for any type of reaction and/or sintering process.

As can be seen in FIGS. 2-4, a furnace 2, in particular a reaction furnace, of the industrial furnace system 1 comprises a chamber 3—preferably one which can be evacuated and/or can be filled with an inert atmosphere—in particular a reaction chamber which has a loading opening 4 (arranged on its underside in the depicted embodiment) for loading the chamber 3 with a loaded crucible 5. A heating device 9, preferably in the form of an induction heater, serves to heat a starting material brought into the chamber 3. The furnace 2 also has a closure device 6 for the loading opening 4. The closure device 6 can be actuated between a closed position and a release position. A control device 10 controls the furnace 2 or its components.

The industrial furnace system 1 further has a transfer device 11, preferably in the form of a robot, for transferring a crucible 5 that can be brought into the chamber 3 through the loading opening 4 to the and/or from the furnace 2. The transfer is preferably performed between the furnace 2 and a loading and/or unloading station 12 for loading and/or unloading a crucible 5 or a transfer station 13 for intermediate storage and/or further transport (FIG. 1).

The control device 10 is configured to move the closure device 6 into the release position for removal of a crucible 5 from the chamber 3.

This can be performed by the control device controlling the transfer device 11 in such a way that the transfer device 11 actuates the closure device (i.e., moves the closure device from the closed position to the release position). For example, in this embodiment an end effector can dock with the closure device 6 or move it into the release position. In other words, the transfer device acts here as an actuator of a (passive, i.e., itself inactive) closure device. Such a variation is represented schematically in FIG. 12.

However, this can also be performed by the control device controlling the closure device, namely depending on the position of the transfer device 11 and/or the position of an end effector 14 of the transfer device. The transfer device or its position serve here merely as a trigger. The closure device has at least one actuator of its own which is controlled by the control device (e.g., upon the transfer device reaching a certain position), such that the closure device moves from the closed to the release position.

If the closure device is in the release position, removal of the crucible 5 from the chamber 3 through the loading opening 4 is performed according to a similar principle: either by actuation of the transfer device 11 (see transition from FIG. 6 to FIG. 7) and/or preferably depending on the position of the transfer device 11 and/or the position of an end effector 14 of the transfer device 11 by actuation of a removal device 26, in particular a lowering device, which is separate from the transfer device 11 (see FIG. 11). The removal device 26 can also have a communication connection with the control device 10 and be controllable by the latter (FIG. 9).

As can be seen in FIGS. 4, 6-7 and 9, the closure device 6 can have at least one, preferably pneumatic or hydraulic, actuator 15 which can be actuated by the control device 10. The control device 10 can be configured to move the closure device 6 into the release position by actuating the at least one actuator 15 in order to remove a crucible 5 from the chamber 3 if an end effector 14 of the transfer device 11 is arranged in front of and/or beneath the loading opening 4 and/or if an end effector 14 of the transfer device 11 contacts the furnace 2 in the region of the loading opening 4 and/or if an end effector 14 of the transfer device 11 contacts a support 7, which is supporting a crucible 5 located in the chamber 3, from the outside (FIG. 6).

As can be seen in FIGS. 6-11, the furnace 2 can have at least one sensor 8, preferably a contact sensor and/or proximity sensor, for detecting the position of the transfer device 11 and/or the position of an end effector 14 of the transfer device 11. The sensor 8 is preferably arranged in the region of the loading opening 4.

The control device 10 can now be configured to receive data regarding the position of the transfer device 11 and/or the position of an end effector 14 of the transfer device 11 from a sensor 8 and/or from the transfer device 11 itself. The transfer device 11 and/or the closure device 6 can now be controlled depending on these sensor data.

The furnace 2 can further have a temperature sensor 16 (see FIGS. 2, 3 and 9). The control device 10 can be configured to receive data from the temperature sensor 16 and to control the transfer device 11 and/or the closure device 6 depending on the data of the temperature sensor 16. For example, the controls can be configured such that the transfer device 11 is only then moved to the furnace 2 and/or the closure device 6 is only then moved to the release position if the temperature in the chamber has cooled to below a critical temperature.

As can be seen in the figures, the furnace 2 can have a, preferably pedestal-like, support 7 for supporting a crucible 5 located in the chamber 3, wherein in its operating position the support 7 closes the loading opening 4 and is fixed by the closure device 6 (see right-hand furnace in FIG. 3) and wherein the support 7, when the closure device 6 is in its release position, can be removed from, in particular lowered out of, its operating position in the chamber 3, preferably by means of the transfer device 11 (see left-hand furnace in FIG. 3). An end effector 14 of the transfer device 11 can be configured to receive the support 7 in the region of its underside (see FIG. 6) and/or to receive a crucible 5 located on the support 7, preferably by means of a gripper (see FIG. 8).

In its operating position, the support 7 can protrude into the inside of the chamber 3 (see FIGS. 2, 3 and 6). Furthermore, the support 7 can be closed off on its underside by a base plate 17 (see FIGS. 4 and 6). In the operating position, the base plate 17 seals the chamber 3 and fits with the edge of the loading opening 4. As already mentioned, at least one temperature sensor 16 can be arranged in or on the support 7, preferably in the form of a thermocouple, for measuring a temperature in the chamber 3 (FIGS. 2 and 3). The support 7 could also have at least one heat shield which is arranged in a cavity of the support 7 (not shown). It is indicated in FIG. 2 that at least one cavity 18 is configured in the support 7, preferably in the form of a duct or a water pocket, for receiving and/or conducting a coolant. Furthermore, at least a passage for a gas line and/or vacuum line and/or electrical line and/or a thermocouple could be configured in the support 7 (not shown).

It can already be seen in FIG. 1 that the industrial furnace system 1 has at least two furnaces 2 combined into one unit 20 and controllable by the control device 10. The control device 10 is thereby preferably configured to unload and/or to clean and/or to reload one furnace 2 (left-hand furnace in FIG. 3) of the unit 20 by controlling the transfer device 11 and/or by controlling the closure device 6 while another furnace 2 of the unit 20 is in production mode (right-hand furnace in FIG. 3).

The unit 20 can have a common, preferably electric, supply device 21, preferably in the form of an induction generator, for the heating devices 9, where said supply device 21 can be configured to be switchable between the furnaces 2 or between the heating devices 9 of the furnaces 2. In the case of an induction heater, in the context of this example embodiment, the heating device is understood as the induction coil (where applicable together with the external resonant circuit). An induction generator and/or an alternating current source then serves as a supply device.

The unit 20 or the units 20 can equally have a common pump and/or gas loading device 22, 23 (see also FIG. 1). Alternatively, each furnace 2 or each unit 20 could have its own pump and/or gas loading device.

The transfer device 11 can be guided on a guideway 25, e.g., on rails, and comprise at least one robotic arm and/or one end effector 14 in the form of a (parallel) gripper.

FIG. 10 shows a particularly preferred embodiment in which the transfer device or its end effector 14 comprises and/or carries a cleaning device 19, wherein preferably the cleaning device 19 can comprise a brush and/or a suction device and/or a compressed air supply. The cleaning device 19 could constitute an additional end effector of the transfer device 11 which is separate from the gripper, or where required could be grabbed and held by the end effector as an aid. In the latter case, the cleaning device 19 could be parked in a parking position and be picked up by the transfer device when required. Common to all of these variations is that in addition to its function for removing the crucible 5 from the chamber 3, the transfer device assumes the function of cleaning the chamber.

In the embodiment shown in FIG. 10, in addition to a rotating brush the cleaning device 19 comprises a cover 19a in the form of a base plate which covers or closes the loading opening 4 in the cleaning mode, and a suction device 19b which sucks residues (dust, soot etc.) out of the chamber. During cleaning of the chamber, the cover 19a prevents the residues from falling out of the chamber in an uncontrolled manner and contaminating the industrial furnace system.

Finally, FIG. 9 schematically shows that the control device 10 has a communication connection with individual components of the industrial furnace system 1 and controls them and/or receives (sensor) data from them.

Finally, the invention also relates to a method for operating an industrial furnace system 1, in particular for producing ceramic materials and/or carbides, in particular silicon carbide,

wherein for removing the crucible 5 from the chamber 3

the closure device 6 is brought into the release position by actuation of the transfer device 11 and/or depending on the position of the transfer device 11 and/or the position of an end effector 14 of the transfer device 11

and/or

a crucible 5 is removed, in particular is lowered, through the loading opening 4 of the chamber 3 when the closure device 6 is in the release position by actuation of the transfer device 11 and/or preferably depending on the position of the transfer device 11 and/or on the position of an end effector 14 of the transfer device 11 by actuation of a removal device, in particular a lowering device, which is separate from the transfer device 11.

As already mentioned, following the removal of the crucible 5 from the chamber 3 the chamber 3 can be cleaned by means of the transfer device 11, wherein preferably an end effector 14 of the transfer device 11 comprises a cleaning device 19 and/or carries a cleaning device 19 during cleaning, wherein the cleaning device 19 preferably comprises a brush and/or a suction device and/or a compressed air supply.

According to a particular embodiment, the industrial furnace system 1 has a plurality of furnaces 2, wherein preferably two furnaces 2 are combined into one unit 20, and the furnaces 2 are unloaded and/or cleaned and/or loaded by means of the same transfer device 11, wherein the furnaces 2 are put into production mode with a time offset by activating the heating device 9.

To remove a crucible 5 from the chamber 3, the transfer device 11 approaches the loading opening 4 with an end effector 14 and the closure device 6 is brought into a release position by means of the transfer device 11 and/or at least one actuator 15 of the closure device 6. The transfer device 11 can subsequently remove, in particular lower, the crucible 5 from the chamber 3.

The industrial furnace system and the method for its operation are in particular suitable for the production of ceramic materials and/or carbides, in particular the production of silicon carbide from silicon oxide and carbon, by means of exothermic reaction and/or for (reaction) sintering.

### LIST OF REFERENCE NUMERALS

1 Industrial furnace system

2 Furnace

3 Chamber

4 Loading opening

5 Crucible

6 Closure device

7 Support

8 Sensor

9 Heating device

10 Control device

11 Transfer device

12 Loading and/or unloading station

13 Transfer station

14 End effector

15 Actuator

16 Temperature sensor

17 Base plate

18 Cavity

19 Cleaning device

19a Cover device

19b Suction device

20 Unit

21 Supply device

22 Pump device

23 Gas loading device

24 Feet

25 Guideway

26 Removal device (lowering device)

1-20. (canceled)

21. An industrial furnace system (1), in particular for producing ceramic materials and/or carbides, in particular silicon carbide, and/or for sintering materials, comprising
at least one furnace (2), in particular a reaction furnace, with a chamber (3)—preferably one which can be evacuated and/or can have an inert atmosphere applied to it—in particular a reaction chamber which has a loading opening (4), preferably arranged on its underside, for loading the chamber (3) with a crucible (5) which is filled with a—preferably powdered—starting material, a heating device (9), preferably in the form of an induction coil and/or induction heater, for heating a starting material brought into the chamber (3) and a closure device (6) for the loading opening (4), where said closure device (6) can be actuated between a closed position and a release position, and
a control device (10) for controlling the at least one furnace (2)
wherein the industrial furnace system (1) has a transfer device (11), preferably in the form of a robot, for transferring a crucible (5) that can be brought into the chamber (3) through the loading opening (4) to the and/or from the furnace (2), preferably between the furnace (2) and a loading and/or unloading station (12) for loading and/or unloading a crucible (5) or a transfer station (13),
wherein, for removing the crucible (5) from the chamber (3), the control device (10) is configured
to bring the closure device (6)—by actuating the transfer device (11) and/or depending on the position of the transfer device (11) and/or the position of an end effector (14) of the transfer device (11)—into the release position and/or
to allow for a crucible (5) to be removed, in particular to be lowered, through the loading opening (4) of the chamber (3) when the closure device (6) is in the release position, by actuating the transfer device (11) and/or depending on the position of the transfer device (11) and/or on the position of an end effector (14) of the transfer device (11) by actuating a removal device (26), in particular a lowering device, which is separate from the transfer device (11).

22. The industrial furnace system according to claim 21, wherein the closure device (6) has at least one, preferably pneumatic or hydraulic, actuator (15) which can be actuated by the control device (10).

23. The industrial furnace system according to claim 21, wherein the closure device (6) comprises at least one own actuator (15) which is separate from the transfer device (11) and which performs the actuation between the closed position and the release position, and wherein, for removal of the crucible (5) from the chamber (3), the control device (10) is configured to bring the closure device (6)—depending on the position of the transfer device (11) and/or the position of an end effector (14) of the transfer device (11)—into the release position, wherein the transfer device (11) serves as a trigger in such a way that upon reaching a certain position the activation of the closure device (6) from the closed to the release position is triggered.

24. The industrial furnace system according to claim 21, wherein the closure device (6) is then brought into a release position by the control device (10) when the transfer device (11) and/or its end effector (14) is in a position in which it is ready for a receipt of the crucible (5) or a support (7) carrying a crucible (5), preferably at such a time as the transfer device (11) has arrived in the region of the loading opening (4) and/or has docked with the chamber (3) or the support (7).

25. The industrial furnace system according to claim 21, wherein, for removal of a crucible (5) from the chamber (3), the control device (10) is configured to bring the closure device (6) into the release position by actuating the at least one actuator (15) if an end effector (14) of the transfer device (11) is arranged in front of and/or beneath the loading opening (4) and/or if an end effector (14) of the transfer device (11) contacts the furnace (2) in the region of the loading opening (4) and/or if an end effector (14) of the transfer device (11) contacts a support (7), which is supporting a crucible (5) located in the chamber (3), from the outside.

26. The industrial furnace system according to claim 21, wherein the furnace (2) has at least one sensor (8), preferably a contact sensor and/or proximity sensor for detecting the position of the transfer device (11) and/or the position of an end effector (14) of the transfer device (11), wherein preferably the sensor (8) is arranged in the region of the loading opening (4).

27. The industrial furnace system according to claim 21, wherein the control device (10) is configured to receive data about the position of the transfer device (11) and/or the position of an end effector (14) of the transfer device (11) from a sensor (8) and/or from the transfer device (11) itself, and/or wherein the control device (10) is configured to receive data from a temperature sensor (16) of the furnace (2) and to control the transfer device (11) and/or the closure device (6) depending on the data of the temperature sensor (16).

28. The industrial furnace system according to claim 21, wherein the furnace (2) has a, preferably pedestal-like, support (7) for supporting a crucible (5) located in the chamber (3), wherein in its operating position the support (7) closes the loading opening (4) and is fixed by the closure device (6) and wherein the support (7), when the closure device (6) is in its release position, can be removed from, in particular lowered out of, the chamber (3), preferably by means of the transfer device (11), wherein preferably an end effector (14) of the transfer device (11) is configured to receive the support (7) in the region of its underside and/or to receive a crucible (5) located on the support (7), preferably by means of a gripper.

29. The industrial furnace system according to claim 28, wherein in its operating position the support (7) protrudes into the inside of the chamber (3) and/or wherein the support (7) is closed off on its underside by a base plate (17) and/or wherein the support (7) has feet (24) protruding downwards on its underside and/or wherein at least one temperature sensor (16), preferably in the form of a thermocouple, is arranged in or on the support (7) for measuring a temperature in the chamber (3) and/or wherein the support (7) has at least one heat shield which is arranged in a cavity of the support (7) and/or wherein at least one cavity (18), preferably in the form of a duct or a water pocket, for receiving and/or conducting a coolant is arranged in the support (7) and/or wherein a passage is configured in the support (7) for a gas line and/or vacuum line and/or electrical line and/or a thermocouple.

30. The industrial furnace system according to claim 21, wherein the industrial furnace system (1) has at least two furnaces (2) combined into one unit (20) and controllable by the control device (10), and wherein the control device (10) is configured to unload and/or to clean and/or to reload one furnace (2) of the unit (20) by controlling the transfer device (11) and/or by controlling the closure device (6) while another furnace (2) of the unit (20) is in production mode.

31. The industrial furnace system according to claim 21, wherein the industrial furnace system (1) has at least two furnaces (2) combined into one unit (20) and controllable by the control device (10), wherein the unit (20) has a common, preferably electric, supply device (21), preferably in the form of an induction generator for the heating devices (9), which are preferably configured as induction coils, said supply device being switchable between the heating devices (9) of the furnaces (2), and/or wherein the unit (20) has one common pump and/or gas loading device (22, 23) which is switchable between the chambers (3).

32. The industrial furnace system according to claim 21, wherein the transfer device (11) is guided on a guideway (25) and/or wherein the transfer device (11) comprises at least one robotic arm and/or wherein an end effector (14) of the transfer device (11) comprises a gripper, preferably a parallel gripper, and/or wherein an end effector (14) of the transfer device (11) comprises and/or carries a cleaning device (19), wherein preferably the cleaning device (19) comprises a brush, which can preferably be set into rotation by a drive, and/or a suction device (19b) and/or a compressed air supply and/or a cover (19a) by means of which the loading opening (4) can be closed.

33. A method for operating an industrial furnace system (1), in particular for producing ceramic materials and/or carbides, in particular silicon carbide, wherein the industrial furnace system (1) has
at least one furnace (2), in particular a reaction furnace, with a chamber (3)—preferably one which can be evacuated and/or can have an inert atmosphere applied to it—in particular a reaction chamber which has a loading opening (4), preferably arranged on its underside, for loading the chamber (3) with a crucible (5) which is filled with a—preferably powdered—starting material, a heating device (9), preferably in the form of an induction coil and/or induction heater, for heating a starting material brought into the chamber (3) and a closure device (6) for the loading opening (4), said closure device (6) being actuable between a closed position and a release position,
a control device (10) for controlling the at least one furnace (2) and
a transfer device (11), preferably in the form of a robot, for transferring a crucible (5) that can be brought into the chamber (3) through the loading opening (4) to the and/or from the furnace (2), preferably between the furnace (2) and a loading and/or unloading station (12) for loading and/or unloading a crucible or a transfer station (13),
wherein for removing the crucible (5) from the chamber (3)
the closure device (6) is brought into the release position by actuating the transfer device (11) and/or depending on the position of the transfer device (11) and/or the position of an end effector (14) of the transfer device (11) and/or
when the closure device (6) is in the release position, a crucible (5) is removed, in particular is lowered, through the loading opening (4) of the chamber (3) by actuating the transfer device (11) and/or preferably depending on the position of the transfer device (11) and/or the position of an end effector (14) of the transfer device (11) by actuating a removal device (26), in particular a lowering device, which is separate from the transfer device (11).

34. The method according to claim 33, wherein the industrial furnace system (1) comprises
at least one furnace (2), in particular a reaction furnace, with a chamber (3)—preferably one which can be evacuated and/or can have an inert atmosphere applied to it—in particular a reaction chamber which has a loading opening (4), preferably arranged on its underside, for loading the chamber (3) with a crucible (5) which is filled with a-preferably powdered-starting material, a heating device (9), preferably in the form of an induction coil and/or induction heater, for heating a starting material brought into the chamber (3) and a closure device (6) for the loading opening (4), where said closure device (6) can be actuated between a closed position and a release position, and
a control device (10) for controlling the at least one furnace (2)
wherein the industrial furnace system (1) has a transfer device (11), preferably in the form of a robot, for transferring a crucible (5) that can be brought into the chamber (3) through the loading opening (4) to the and/or from the furnace (2), preferably between the furnace (2) and a loading and/or unloading station (12) for loading and/or unloading a crucible (5) or a transfer station (13),
wherein, for removing the crucible (5) from the chamber (3), the control device (10) is configured
to bring the closure device (6)—by actuating the transfer device (11) and/or depending on the position of the transfer device (11) and/or the position of an end effector (14) of the transfer device (11)—into the release position and/or
to allow for a crucible (5) to be removed, in particular to be lowered, through the loading opening (4) of the chamber (3) when the closure device (6) is in the release position, by actuating the transfer device (11) and/or depending on the position of the transfer device (11) and/or on the position of an end effector (14) of the transfer device (11) by actuating a removal device (26), in particular a lowering device, which is separate from the transfer device (11).

35. The method according to claim 33, wherein the closure device (6) comprises at least one own actuator separate from the transfer device (11), which actuator performs the actuation between the closed position and the release position, and wherein for removing a crucible (5) from the chamber (3) the closure device (6)—depending on the position of the transfer device (11) and/or the position of an end effector (14) of the transfer device (11)—is brought into the release position by the control device (10) of the industrial furnace system (1), wherein the transfer device (11) serves as a trigger in such a way that upon reaching a certain position the activation of the closure device (6) from the closed to the release position is triggered.

36. The method according to claim 33, wherein the closure device (6) is then brought into a release position by the control device (10) when the transfer device (11) and/or its end effector (14) is in a position in which it is ready for a receipt of the crucible (5) or a support (7) carrying a crucible (5), preferably at such a time as the transfer device (11) has arrived in the region of the loading opening (4) and/or has docked with the chamber (3) or the support (7).

37. The method according to claim 33, wherein following the removal of the crucible (5) from the chamber (3) the chamber (3) is cleaned by means of the transfer device (11), wherein preferably an end effector (14) of the transfer device (11) comprises a cleaning device (19) and/or carries a cleaning device (19) during cleaning, wherein preferably the cleaning device (19) comprises a brush, which can preferably be set into rotation by a drive, and/or a suction device (19b) and/or a compressed air supply and/or a cover (19a), by means of which the loading opening (4) can be closed.

38. The method according to claim 33, wherein the industrial furnace system (1) has at least two furnaces (2) combined into one unit (20) and controllable by the control device (10), and wherein one furnace (2) of the unit (20) is unloaded and/or cleaned and/or reloaded by controlling the transfer device (11) and/or by controlling the closure device (6) while another furnace (2) of the unit (20) is in production mode.

39. The method according to claim 33, wherein the industrial furnace system (1) has a plurality of furnaces (2), wherein preferably two furnaces (2) are combined into one unit (20), and wherein the furnaces (2) are unloaded and/or cleaned and/or loaded by means of the same transfer device (11), wherein the furnaces (2) are put into production mode with a time offset, preferably by means of evacuating the chamber (3) and/or by introducing an inert atmosphere into the chamber (3) and/or by activating the heating device (9).

40. The method according to claim 33, wherein for removing a crucible (5) from the chamber (3) the transfer device (11) approaches the loading opening (4) with an end effector (14) and the closure device (6) is brought into a release position by means of the transfer device (11) and/or at least one actuator (15) of the closure device (6).

41. The method according to claim 33, wherein the transfer device (11) removes, in particular lowers, the crucible (5) from the chamber (3).

42. The method according to claim 33, wherein the furnace (2) has a, preferably pedestal-like, support (7) for supporting a crucible (5) located in the chamber (3), wherein when in its operating position the support (7) closes the loading opening (4) and is fixed by the closure device (6) and wherein the transfer device (11) removes the crucible (5) from the chamber (3) in that the transfer device (11) removes, in particular lowers, the support (7) together with the crucible (5) from its operating position in the chamber (3).

43. The method according to claim 42, wherein an end effector (14) of the transfer device (11) removes the crucible (5) from the removed, in particular lowered, support (7), wherein preferably the transfer device (11) transfers the removed support (7) to a loading and/or unloading station (12) to load or unload the crucible (5) or to a transfer station (13).

44. A method for producing ceramic materials and/or carbides, in particular for producing silicon carbide from silicon oxide and carbon, by means of exothermic reaction and/or for the sintering of materials, wherein preferably powdered starting materials, in particular an oxide and carbon, are filled into a crucible (5),
wherein the filled crucible (5) is placed into a furnace (2) of an industrial furnace system (1), wherein the industrial furnace system (1) is configured according to claim 21 and/or wherein the industrial furnace system (1) is operated according to a method wherein for removing the crucible (5) from the chamber (3)
the closure device (6) is brought into the release position by actuating the transfer device (11) and/or depending on the position of the transfer device (11) and/or the position of an end effector (14) of the transfer device (11) and/or
when the closure device (6) is in the release position, a crucible (5) is removed, in particular is lowered, through the loading opening (4) of the chamber (3) by actuating the transfer device (11) and/or preferably depending on the position of the transfer device (11) and/or the position of an end effector (14) of the transfer device (11) by actuating a removal device (26), in particular a lowering device, which is separate from the transfer device (11).
